(19) United States
(12) Patent Application Publication
(10) Pub. No.: US 2019/0378154 A1
(43) Pub. Date: Dec. 12, 2019

(54) System And Method For Real-Time Demand Stimulation

(71) Applicants: Harold Edward Elkins II, Frisco, TX (US); Vale Asche Elkins, Frisco, TX (US)

(72) Inventors: Harold Edward Elkins II, Frisco, TX (US); Vale Asche Elkins, Frisco, TX (US)

(21) Appl. No.: 16/003,075

(22) Filed: Jun. 7, 2018

(51) Int. Cl. G06Q 30/02; G06Q 10/06

(52) U.S. Cl. CPC G06Q 30/0223; G06Q 10/067; G06Q 30/0261; G06Q 30/0212; G06Q 30/0269

(57) ABSTRACT

An exemplary system and method are provided for a seller to increase demand in real-time by providing an incentive(s) or condition(s) for a consumer to purchase otherwise unused products, services or capacity, and notifying potential customers of the incentive(s) in real-time. The method may include offering a reduced price or other incentive at the last minute, initiating communications via an electronic communications platform, alerting potential customers of the incentive, directing the customer to the event or location, and making the purchase transaction.

### BACKGROUND OF THE INVENTION

The present invention relates generally to systems and methods for the stimulation of demand for products and services and more particularly, but not by way of limitation, to a system and method for stimulating demand for products and services in real-time. Many products and services go unused because of mismatches in supply and demand. This is particularly true of products and services that have a significant capacity value that becomes worthless once the capacity, or event, has expired. For example, an empty airline seat has no value once the plane has taken off and a concert event seat is worthless once the concert is over. So it goes for other products and services such as theatre tickets and sporting events. In addition, other products and services, such as a restaurant meal, a massage, a manicure, a bowling lane, a round of golf, hotel nights, cruise staterooms and other similar products and services have very low short-term marginal costs and go un-sold and waste the capacity value of the provider.

Using the sporting event example, with the current state of the art, providers have limited options to fill empty seats at the last minute when they realize there are a number of un-sold seats. And in the case of a restaurant that is usually almost full at 7:30 pm on a Wednesday night, there is little a restaurateur can do to bring in additional customers at the last minute once they see the unusual lack of diners. This situation results in a loss of significant potential revenue that otherwise could increase a provider's profitability.

### BRIEF SUMMARY OF THE INVENTION

From the foregoing it may be appreciated that a need has arisen for a system and method for increasing demand at the last minute for expiring goods or otherwise unused capacity. While many systems and methods exist that attempt to increase demand in predicted off-peak times, or in longer periods of reduced demand, the current state of the art does not provide a way for providers to boost demand in real-time over a variety of products and services. In accordance with the present invention, a system and method for increasing demand in real-time are provided that substantially eliminate one or more of the disadvantages and problems outlined above.

According to an aspect of the present invention, a method, and a system for carrying out the method, is provided for a seller to increase demand by providing an incentive(s) for a consumer to purchase otherwise unused products, services or capacity, and notifying potential customers of the incentive(s) in real-time. The method may include offering a reduced price or other incentive at the last minute, initiating communications via an electronic communications platform, alerting potential customers of the incentive, and directing the customer to the event or location.

According to another aspect of the invention, a system for implementing the method may be provided that will, preferably, be implemented using a computer system or network, such as the Internet or some other widely accessible wired or wireless network, that includes a plurality of clients and servers. In one aspect, a smartphone app is provided that allows for a provider to offer an incentive, to alert consumers of the incentive, and to allow the consumer to navigate to the provider's location. Such a system allows for users/consumers to easily and conveniently access an implementation of an aspect of the invention to purchase a product and benefit from the incentive, while allowing a seller to minimize its otherwise un-sold goods or capacity while utilizing the significant economic advantages of one or more aspects of the invention.

As a further feature of the above aspect, the method may include a Global Positioning System (GPS) based system for identifying and notifying consumers who are in the general geographical area of the product or service and who may be likely potential customers. Yet further features may include a smartphone app that potential customers would utilize when in the process of deciding where to eat, where to shop, what to do, or where to go, informing them of the incentive. Further, the system may utilize GPS based geo blocking to block visibility of the incentive to customers already at the location.

Another implementation of the invention includes alerting consumers of incentives based on a particular purchaser's preferences or interests stored in a profile.

The various embodiments and implementations of the present invention may provide a profusion of potential technical advantages and benefits that may include one or more of the following. A technical advantage of the present invention may include the capability to provide an incentive for consumers to receive a discount or other incentive to purchase a product or utilize a service at the last minute that otherwise would be left un-sold or un-used.

Another technical advantage of the present invention is to alert potential customers of the incentive when they are searching for that type of product or service, increasing the likelihood that the potential customer will take advantage of the incentive, thus increasing demand and sales.

Yet another technical advantage of the present invention may include notifying potential customers of the incentive based on a match with a profile the potential customer had previously completed, also increasing the likelihood that the potential customer will take advantage of the incentive, thus increasing demand and sales. This benefits both consumers and sellers by providing a system where maximum value can be provided to both sides of a transaction by providing a personalized profile of a user or consumer to determine what that consumer prefers and hence would constitute value for that consumer. For example, a directed offer related to golf is of more value to a consumer that enjoys golf, as determined from a prior personalized profile.

Technical advantages in certain implementations and instances can be significant. For example, advantages from a restaurant's implementation may include some of the following: provides robust demand management tool for low demand times; creates competitive advantage over restaurants without the tool; improves profitability, and provides benefits to customers which strengthens customer relationships. Advantages from a customers standpoint may include one or more of the following: provides information on convenient options and provides benefits such as reduced prices and navigation aids.

Other technical advantages and benefits may be readily apparent to one skilled in the art from the following detailed description of the invention when read in conjunction with the accompanying figures, description, appendix and aspects of the invention.

### BRIEF DESCRIPTION OF THE SEVERAL VIEWS OF THE DRAWINGS

For a more complete understanding of the present invention and the advantages thereof, reference is now made to the following brief description, taken in connection with the accompanying drawings and detailed description, wherein like reference numerals represent like or similar parts or aspects, in which:

FIG. 1 is a block diagram of a system and method for stimulating demand for products in real-time, according to an embodiment of the present invention;

FIG. 2 is a block schematic diagram of the seller device shown in FIG. 1 according to an embodiment of the present invention;

FIG. 3 is a flowchart of a system and method for stimulating demand for products in real-time, according to an aspect of the present invention;

FIG. 4 is an example of an aspect of a mobile smartphone app illustrating an implementation of the Buyer Device referenced in 300 of FIG. 1;

FIG. 5 is an example of another aspect of a mobile smartphone app further illustrating an implementation of the Buyer Device referenced in 300 of FIG. 1;

FIG. 6 is a graph illustrating a supply and demand curve illustrating the effect of an incentive offered via the present invention and subsequent seller benefit for such an implementation;

### DETAILED DESCRIPTION OF THE INVENTION

It should be understood at the outset that although an exemplary implementation of the present invention is illustrated below, the present invention may be implemented using any number of techniques, computer and communications systems, whether currently known or in existence. The present invention should in no way be limited to the exemplary implementations, drawings, and techniques illustrated below, including the exemplary design and implementations illustrated and described herein. Additionally, the drawings contained herein are not necessarily drawn to scale.

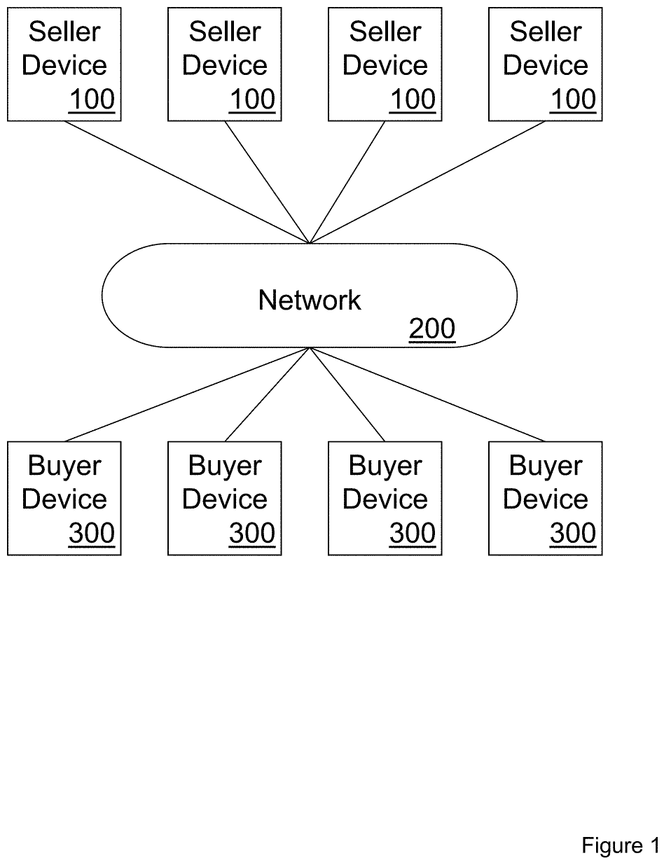

Before each individual FIG. 1s discussed, several aspects of the invention are discussed below. A system and method for stimulating demand for products in real-time such as, for example, airline tickets, concert tickets, Broadway play tickets, sporting event tickets, hotel rooms, auctioned items, golf tee times, and other products (or services) whose value diminishes significantly at some future time, which may be referred to as an expiration time. It should be understood that the term “product” or “products,” as used herein, should be understood to also include “service” or “services,” respectively. It should also be understood that an expiration time may be an exact time, or may include a range of times, depending on the product, and how it is defined and used.

The incentive offers could be determined at least in part based upon a profile or knowledge of the purchaser, and wherein the profile includes information about the purchaser. For example, if the purchaser has previously accepted an offer for a discount at a particular hotel chain, a similar offer might be made to that customer in the future. If the customer's profile indicated the customer enjoyed golf or tennis, an offer related to such products could be integrated and included in the directed offer, including incentives.

Various implementations of this method are envisioned and contemplated. The incentive offer could include a reduced price, a discount, a free product, a gift, a complementary product, a cash payment; a voucher; an airline mileage credit in an airline promotional program; or other incentive.

The offerings and the acceptances could be done electronically. The payment could be received electronically. A computer could be used in determining incentive offers. Virtually any known or available computer/communications system may be utilized to implement any number of embodiments of the present invention, each of which would be understood or known by one of ordinary skill in the art.

This method could be applied to a variety of products including airline tickets, concert tickets, sporting events, other live events, train tickets, theatre tickets, movies, hotel rooms, options to buy real estate, options to invest in time-share real estate, options to buy investment securities, options to buy personal property, an item that is to be auctioned at a future time, a scheduled medical procedure, a scheduled use of medical diagnostic equipment, a car rental reservation, a rental reservation for an object, and an appointment to see a professional.

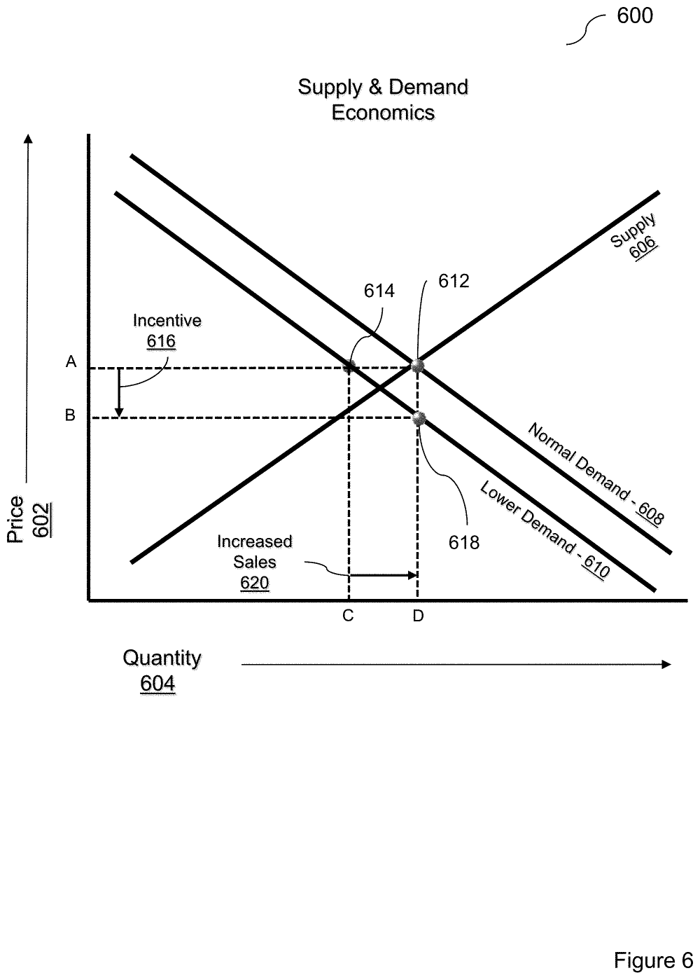

To illustrate the benefits of the method, a few examples of theoretical implementations of the invention are described below, and later in connection with FIG. 6.

A concert example is described here. A venue has a popular local performer booked for an evening concert. The venue expects to sell about half of the seats in advance and the other half at the door. Three days before the concert the manager is concerned at the low sales and implements traditional marketing techniques including special offers and discounts via email and their website. Forty-five minutes before the concert is to begin the manager realizes they have sold about half as many advance seats as expected and that very few customers are arriving to purchase at the door. The manager decides to use the current invention to increase demand in real-time and creates an incentive offer, half-price tickets for this evening's concert, and enters it into the present invention. The system identifies potential customers based on a customer profile match and sends electronic messages to these customers with details of the incentive offer. Some of these customers use the invention to purchase seats at half-price, and others go to the concert location, show the incentive offer on the app, and purchase half-price tickets at the door. The incentive offer also appears on the smartphone app as a current event with an incentive offer. Several users in the nearby geographic area are currently looking for an event to attend, see the offer, and use the tool to navigate to the venue where they show the incentive offer on the app and purchase half-price tickets at the door. As a result of the invention, the venue sells an additional 45 seats, representing a significant increase in revenues and profitability.

A restaurant meal example is described next. The restaurant is normally almost full on Thursday night. At 7:00 pm on Thursday night the manager realizes they have an unusually slow night. Having already purchased enough fresh ingredients and scheduled enough employees for a busy night, the manager decides to use the current invention to increase demand in real-time and creates an incentive offer, 2-for-1 entrées for this evening. The system identifies potential customers based on a customer profile match and sends electronic messages to these customers with details of the incentive offer. Some of these customers go to the restaurant, show the incentive offer on the app, and purchase 2-for-1 entrées along with appetizers, desserts, and drinks. The incentive offer also appears on the smartphone app, utilizing GPS hardware and software, as a nearby restaurant with an incentive offer. Several users are currently looking for a place to eat, see the offer, and use the tool to navigate to the restaurant where they show the incentive offer on the app and purchase 2-for-1 entrées along with desserts and drinks. To avoid alerting current customers to the offer, the system utilizes geo blocking to block visibility of the incentive to customer smartphones already at the location. As a result of the invention, the restaurant serves an additional 32 guests, representing a significant increase in revenues and profitability.

Similar examples can be envisioned related to Broadway plays, ballets, operas, symphony orchestras, sporting events, hotels, all-inclusive resorts, airline tickets, cruises, and other products, as defined herein.

The proper implementation and operation of the invention has the potential to significantly increase a provider's profitability, create a competitive advantage over companies without the invention, provide a robust real-time demand management tool for low demand products, create a profitable two-way marketing channel, and strengthen the customer relationship.

FIG. 1 is a block diagram of a system and method for stimulating demand for products in real-time according to an embodiment of the present invention. This may include client and server computers in communication with one another through a network, such as a network 200 as shown in FIG. 1. The system may include one or more seller devices 100, and a plurality of buyer devices 300 in communication with one another through the network 200. The network 200 may be the Internet, an intranet, a local area network, a wide area network, a collection of numerous networks, cellular phone network, wireless network or networks, or virtually any communication link.

In operation, a purchaser may use one of the buyer devices 300, which may be implemented as client devices, using the network 200, to communicate with one or more of the seller devices 100, which may be implemented as a server or distributed clients, so that a perishable product or service may be purchased according to the invention. Each of the seller devices 100 may be viewed, in one implementation, as separate systems implementing an aspect or aspects of the present invention to sell a plurality of products. In other embodiments, the multiple seller devices may be viewed as a redundant or distributed system for increased system reliability and performance.

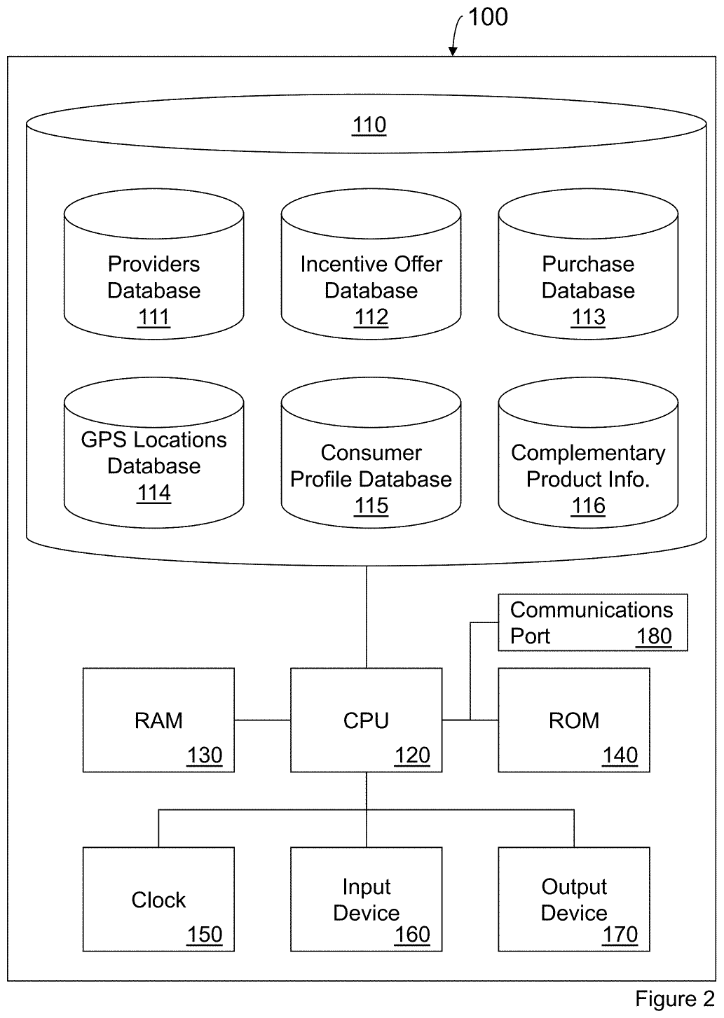

FIG. 2 is a block schematic diagram of the seller device 100 shown in FIG. 1 according to an embodiment of the present invention. Although illustrated as one unit, it should be understood that the various elements of seller device 100 may actually be implemented on various disparate computers and databases to achieve the desired functionality. Conversely, some of the elements of the seller device 100 shown as separate elements may actually be integrated into the same element.

The seller device 100 includes a storage media 110, such as a hard drive or magnetic or optical storage media to store a plurality of databases, such as a providers database 111, an incentive offers database 112, a purchase database 113, a GPS locations database 114, a Consumer Profile database 115, and a complementary product information database 116. These data repositories are used by a CPU 120 (or multiple CPUs), which may also be referred to as a processor 120, for executing computer or machine code instructions provided by computer software. A RAM 130, and a ROM 140 serve as memory or media for the CPU 120 so that computer instructions and/or data may be stored temporarily or as needed while the seller device 100 performs the method, or aspects of the method to increase demand for, and optionally, sell a product or service. A clock 150 is provided so that appropriate clock cycles and timing can be maintained by the seller device 100.

Various I/O devices or elements are illustrated in FIG. 2. For example, an input device 160, an output device 170, and a communications port 180, so that data may be input or output from the device as required. The output device 170 may be, for example, a video monitor or a storage device, such as a CD. Depending on various factors and as desired, the seller device 100 may be implemented as a mobile phone, a personal computer, a laptop computer, a server, a wireless device, a data appliance, and the like. One of ordinary skill in the art could implement one or more aspects of the invention in virtually any available or desired computer system or systems, or networks.

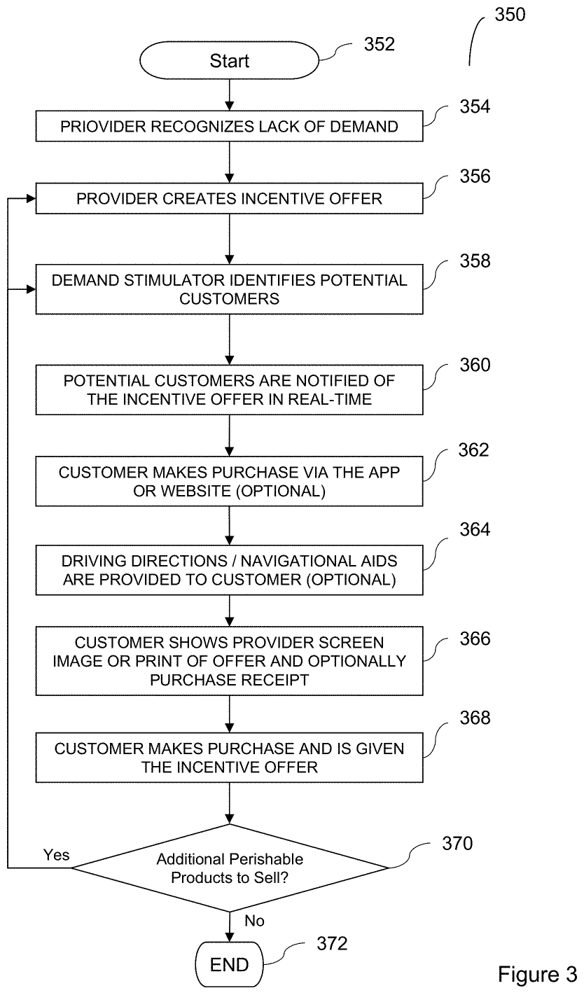

FIG. 3 is a flowchart of a method, and a system for carrying out the method, for a seller to increase demand in real-time by providing an incentive(s) for a consumer to purchase otherwise unused products, services or capacity, and notifying potential customers of the incentive(s) in real-time. The method may include offering a reduced price or other incentive at the last minute, initiating communications via an electronic communications platform, alerting potential customers of the incentive, and directing the customer to the event or location.

The method 350 is one embodiment or implementation of various aspects of the invention, and the present invention should not be limited only to such an embodiment or implementation. The method 350 begins at start block 352 and proceeds to block 354 where the provider recognizes a lack of demand for products, services, or capacity.

The method 350 may proceed next to block 356 where an incentive offer may be determined. In one embodiment, the incentive may be a reduced price, a discount, a free product, a gift, a complementary product, a cash payment; a voucher; an airline mileage credit in an airline promotional program; or other incentive.

In some implementations, an incentive will be provided to the purchaser with the additional opportunity to receive a larger incentive. This opportunity may be provided through a lottery, random drawing or other game or system of chance. This provides additional potential incentive to have buyers purchase using this system.

Proceeding next to block 358, the invention identifies potential customers based on information stored in the consumer profile database (FIG. 2, block 115); or based on the potential customer's location or current selections and searches while using a user device such as a laptop or smartphone with a GPS system and the app.

Proceeding to block 360, the method and system notifies potential customers of the incentive in real-time. In a preferred embodiment, notice of the incentive will be provided electronically, such as through a smartphone app, email, text message, web portal or networked computer system that allows multiple consumers to view the incentive offer.

In one embodiment or implementation, the incentive is selected based upon the customer's profile. In a preferred implementation, this is stored and is electronically available to the system of the present invention to assist with determining the purchaser's likes and dislikes in order to properly motivate the purchaser.

As used here in describing the invention, method, process, and system, real-time means at the current time, at approximately the current time, or in a relevant time period such that the incentive offer can be communicated to potential customers and acted upon before the product expires or the capacity value has passed.

As used here in describing the invention, method, process, and system, increasing demand in real-time means increasing demand at the current time, at approximately the current time, or in a relevant time period such that the incentive offer can be communicated to potential customers and acted upon before the product expires or the capacity value has passed.

Proceeding next to block 362, a consumer, buyer or user, such as the first purchaser, acts upon the offer and purchases the product, as described above. In a preferred embodiment, this is done electronically such that the purchaser electronically accepts the offer, and preferably, provides for electronic payment at the time of acceptance.

Proceeding to block 364, in one implementation of the current invention, some consumers may utilize the smartphone app to provide driving or walking directions to the seller. In yet another implementation of the invention, the smartphone app may provide the location details to another app installed on the user device to provide navigational aids.

Proceeding next to block 366, in one implementation of the current invention, some consumers may utilize the smartphone app to show the seller the incentive offer when making the purchase. Other customers may print the incentive offer or bring other evidence of the offer when making the purchase.

Proceeding to block 368, in one implementation of the current invention, the customer makes the purchase and is given the incentive. The seller realizes increased profits and builds positive customer relationships. As can be seen, the invention provides a powerful demand management or yield management tool to maximize overall revenue while providing enhanced benefits to consumers.

Proceeding to block 370, in one implementation of the current invention, the provider may withdraw the offer as shown in block 372, continue the offer as shown in block 358, or create a different incentive as shown in block 356. One or more additional products may be processed and sold according to method 350.

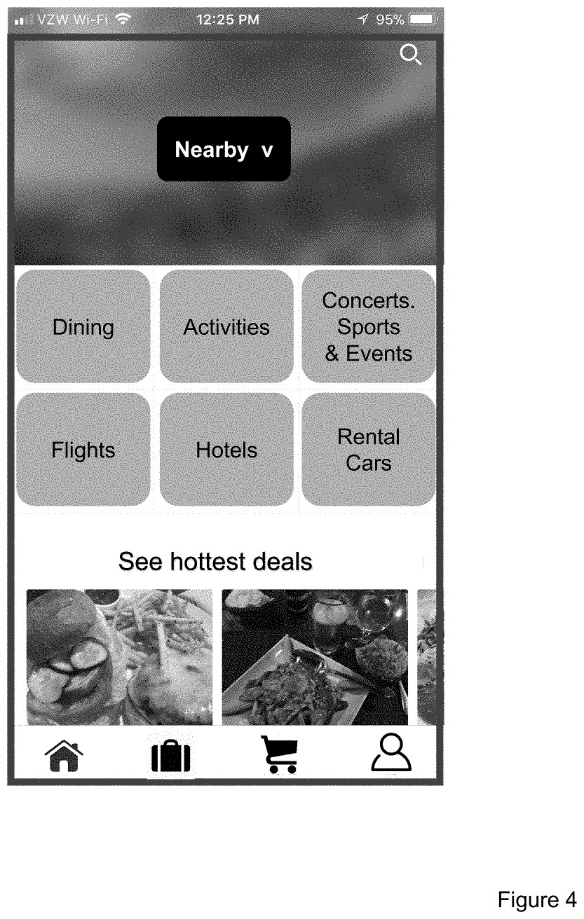

FIG. 4 is an example of a smartphone app that could be utilized as a buyer device, as discussed in FIG. 1, block 300; in one implementation of the present invention. On logging into the app, the user would be presented with several categories of products and services to browse for incentives, or “deals”. The default would be for business nearby based on GPS information, but the user could also search in other locations. The section at the bottom could be provided to view the “hottest deals”. A search feature is provided at the top, and navigation icons are provided at the bottom of the screen.

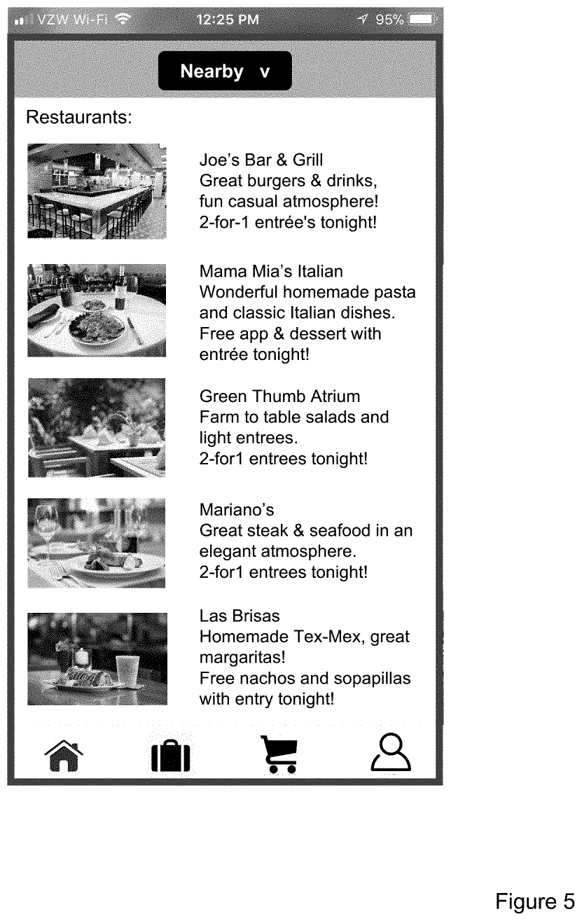

FIG. 5 is an example of another screen of a smartphone app that could be utilized as a buyer device. Once the user selects a category of business to browse as discussed in FIG. 4, this screen would display the relevant businesses in that category and location that are currently offering incentives. The user could scroll through the choices until they see the one they prefer. After the user selects a business, the app would display the address, phone number, details of the incentive, optionally facilitate an online purchase, and optionally provide driving directions.

In a preferred implementation, users or purchasers may access the system remotely to access the method 350 through any network device, including personal computers, PDAs, mobile phones, and virtually any known or available device that allows access to the system through a wired or wireless interface or network. Similarly, all payments are preferably made electronically, and all notices and notifications are made electronically through a web portal or other GUI interface. In a preferred embodiment, the method 350 is performed through an electronic commerce system and/or computer-based system, such as an Internet implemented commerce system.

FIG. 6 is a graph 600 illustrating a supply and demand curve commonly used in economics to model seller and buyer behavior in the marketplace. The Price axis 602 is on the left and the Quantity axis 604 is at the bottom. The Supply curve 606 typically slopes upward to the right indicating that the marketplace will be willing to provide larger quantities of goods as the price increases, and vice versa. The Normal Demand curve 608 slopes downward to the right indicating that consumers will demand less of a product as the price increases. When conditions in the marketplace are normal, equilibrium occurs where the supply curve and the demand curve cross, illustrated by point 612. This is the point at which supply and demand are in balance and just the right quantity of goods are supplied (Point D) at the right price (Point A) to meet the quantity demanded by consumers. However, disruptions in the marketplace sometimes cause temporary imbalances in supply and demand. This can be as major as an oil embargo or as minor as a playoff football game in a small town, temporarily reducing demand for restaurant meals. The second example results in a temporary reduction in demand, Line 610. At normal price (Point A), the marketplace will demand fewer goods (Point 614 and Point C), resulting in a surplus of goods supplied (Point D minus Point C). When faced with this situation, suppliers have few options to increase demand in the short-term.

The present invention offers a way for suppliers to immediately increase demand for their products. In the restaurant meal example, the supplier can initiate an incentive offer, such as a reduced price or two-for-one meals (616), reach potential customers with the incentive, and temporarily stimulate demand and increase sales (620). As a result, otherwise unsold goods will be sold with a reduced price or other incentive, increasing revenue, contribution margin, and profits. The present invention therefore creates a competitive advantage for users over suppliers without the benefit of the present invention.

1. A system and method for the stimulation of demand for products and services and more particularly, but not by way of limitation, to a system and method for stimulating demand for products and services in real-time, the method comprising:
determining an incentive offer to sell a product;
offering to sell the product with the incentive offer;
communicating the offer to targeted consumers in real-time;
receiving an acceptance from a purchaser to sell the product with the incentive offer.

2. The method of claim 1, wherein the product includes one from the group that consists of an airline ticket, a concert ticket, a sporting event ticket, a ticket to a live event, a train ticket, a theatre ticket, a ticket to a movie, a hotel room reservation, a restaurant meal, a massage, a manicure, a bowling lane, an activity, a round of golf, cruise staterooms, an option to buy real estate that expires at a future time, an option to invest in a time-share real estate that expires at a future time, an option to buy an investment security that expires at a future time, an option to buy personal property that expires at a future time, an item that is to be auctioned at a future time, a scheduled medical procedure, a scheduled use of medical diagnostic equipment, a car rental reservation, a product, a service, a rental reservation for an object, and an appointment to see a professional.

3. The method of claim 1, wherein the incentive offer includes at least one from the group that consists of an airline mileage credit in an airline promotional program, a credit in a loyalty program, a discount on a product that is complementary to the first perishable product, a free product, a discount on a product, a discount on a service that is complementary to the first perishable product, a free service, a discount on a service, a discount on an activity, a free activity, a voucher, and a gift card.

4. The method of claim 1, wherein the incentive offer is determined at least in part based upon a profile of the purchaser, and wherein the profile includes information about the purchaser.

5. The method of claim 1, wherein the incentive offer includes an offer to receive a discount on another product.

6. The method of claim 5, wherein the other product is complimentary to the first product.

7. The method of claim 1, wherein the incentive offer for the product includes a credit towards purchasing other products in the future.

8. The method of claim 1 where the incentive amount is based on chance.

9. The method of claim 8, wherein the chance is determined from a random drawing.

10. The method of claim 8, wherein the chance is determined from a lottery game.

11. The method of claim 1, wherein the offerings and the acceptances are done electronically.

12. The method of claim 1, wherein determining the incentive offer is done using a processor to execute instructions stored in a memory.

13. The method of claim 1, wherein determining the targeted consumers is done using a processor to execute instructions stored in a memory.

14. The method of claim 1, further comprising: displaying information about the incentive offer for the product through a web portal.

15. The method of claim 1, further comprising: displaying information about the incentive offer through a wireless device.

16. The method of claim 1, wherein the method is implemented using a computer network.

17. The method of claim 1, wherein the method is implemented using a wireless network.

18. The method of claim 1, wherein the method is a computer-implemented method.

19. The method of claim 1, wherein the method is implemented at least in part by a smartphone app.

20. The method of claim 1, wherein the targeted consumers are identified at least in part based upon a profile of the purchaser, and wherein the profile includes information about the purchaser.

21. The method of claim 1, wherein the targeted consumers are identified at least in part based upon the purchaser's current location utilizing GPS hardware and software.

22. The method of claim 1, wherein the targeted consumers are identified at least in part based upon previous purchases.

23. The method of claim 1, wherein the targeted consumers are identified at least in part based upon the purchaser's current browsing activity.

24. The method of claim 1, wherein the targeted communications is performed via one of the group consisting of email communications, text messaging, electronic communications, web-based communications, data communications, and telephony based communications.

25. A system and method for the stimulation of demand for products and services and more particularly, but not by way of limitation, to a system and method for stimulating demand for products and services in real-time, the method comprising:
determining current conditions to sell a product;
offering to sell the product with the current conditions;
communicating the offer to targeted consumers in real-time;
receiving an acceptance from a purchaser to sell the product with the current conditions.

26. The method of claim 25, wherein the product includes one from the group that consists of an airline ticket, a concert ticket, a sporting event ticket, a ticket to a live event, a train ticket, a theatre ticket, a ticket to a movie, a hotel room reservation, a restaurant meal, a massage, a manicure, a bowling lane, an activity, a round of golf, cruise staterooms, an option to buy real estate that expires at a future time, an option to invest in a time-share real estate that expires at a future time, an option to buy an investment security that expires at a future time, an option to buy personal property that expires at a future time, an item that is to be auctioned at a future time, a scheduled medical procedure, a scheduled use of medical diagnostic equipment, a car rental reservation, a product, a service, a rental reservation for an object, and an appointment to see a professional.

27. The method of claim 25, wherein the current conditions include at least one from the group that consists of the price, the terms, and a time limit.

28. The method of claim 25, wherein the offerings and the acceptances are done electronically.

29. The method of claim 25, wherein determining the current conditions is done using a processor to execute instructions stored in a memory.

30. The method of claim 25, wherein determining the targeted consumers is done using a processor to execute instructions stored in a memory.

31. The method of claim 25, further comprising: displaying information about the offer for the product through a web portal.

32. The method of claim 25, further comprising: displaying information about the offer through a wireless device.

33. The method of claim 25, wherein the method is implemented using a computer network.

34. The method of claim 25, wherein the method is implemented using a wireless network.

35. The method of claim 25, wherein the method is a computer-implemented method.

36. The method of claim 25, wherein the method is implemented at least in part by a smartphone app.

37. The method of claim 25, wherein the targeted consumers are identified at least in part based upon a profile of the purchaser, and wherein the profile includes information about the purchaser.

38. The method of claim 25, wherein the targeted consumers are identified at least in part based upon the purchaser's current location utilizing GPS software and hardware.

39. The method of claim 25, wherein the targeted consumers are identified at least in part based upon previous purchases.

40. The method of claim 25, wherein the targeted consumers are identified at least in part based upon the purchaser's current browsing activity.

41. The method of claim 25, wherein the targeted communications is performed via one of the group consisting of email communications, text messaging, electronic communications, web-based communications, data communications, and telephony based communications.
